(19) United States
(12) Patent Application Publication
(10) Pub. No.: US 2023/0331026 A1
(43) Pub. Date: Oct. 19, 2023

(54) FOLDING STRUCTURE FOR A PLASTIC PLURAL-SHEET STATIONARY

(71) Applicant: MING-HAN WU, TAINAN CITY (TW)

(72) Inventor: MING-HAN WU, TAINAN CITY (TW)

(21) Appl. No.: 17/659,710

(22) Filed: Apr. 19, 2022

(51) Int. Cl. B42F 7/06

(52) U.S. Cl. CPC B42F 7/06

(57) ABSTRACT

A plastic plural-sheet stationary includes plural plastic sheets that are superimposed on one another. The plastic plural sheets includes at least two element sheets made of plastic. The outermost element sheet includes a folding edge. Two first fusion lines are provided to securely connect the plural plastic sheets formed by the superimposed element sheets through fusion. The two first fusion lines are located on two sides of the folding edge. A spacing between the two first fusion lines is greater than twice a superimposed thickness of the plural plastic sheets. Thus, although a corrugation area is generated when the plural plastic sheets are folded along the folding line, the corrugation area is restricted between the two first fusion lines to maintain the region outside of the two first fusion lines smooth, avoiding outward spread of the corrugation area.

### BACKGROUND OF THE INVENTION

The present invention relates to a stationary and, more particularly, to a folding structure for a plastic plural-sheet stationary.

Foldable folders, including but not limited to document folders, are widely used in the field of stationary. The description of an example document folder is set forth hereinafter. As shown in FIG. 6, during use of an ordinary document folder 2 in a folded state, since the document folder 2 includes two plastic sheets 21 and 22 connected end to end, an irregular corrugation area 23 is present in the folding portion. This is because an “inner side effect” occurs at the folding portion after folding the two plastic sheets 21 and 22. The term “inner side effect” used herein refers to corrugations generated around the folding portion of the plastic sheet at the inner side. Due to the “inner side effect” acting on the plastic sheet 22 at the inner side, irregular corrugations are generated in the inner plastic sheet 22 around the folding portion after folding the two plastic sheets 21 and 22. The corrugations have different sizes, are twisted irregularly, or are sinuate arbitrarily. The plastic sheet 21 at the outer side will be affected by the inner plastic sheet 22 with the corrugations, such that the overall smoothness of the plastic sheet 21 at the outer side is affected (the inner side is uneven, such that the outer side is also uneven to the touch). As a result, if the corrugation area is not controlled and/or reduced, the corrugation area will expand and, thus, significantly affect the smoothness and use of the document folder. Since the “inner side effect” is inevitable, reduction of the area affected by the “inner side effect” to reduce the sinuate area or the irregularly twisted area for the purposes of improving the quality of a document folder with plural to-be-folded sheets is an issue to be solved in the art.

### BRIEF SUMMARY OF THE INVENTION

In view of the problems of the prior art, an improved structure is required after understanding the cause of the above problems.

To solve the above problems, the present invention provides a plastic plural-sheet stationary comprising plural plastic sheets that are superimposed on one another. The plastic plural sheets includes at least two element sheets made of plastic. The outermost element sheet includes a folding edge. Two first fusion lines are provided to securely connect the plural plastic sheets formed by the superimposed element sheets through fusion. The two first fusion lines are located on two sides of the folding edge. A spacing between the two first fusion lines is greater than twice a superimposed thickness of the plural plastic sheets.

Firstly, since the plural sheets (such as first and second plastic sheets) in the present invention are made of plastic material which is elastic, the plural sheets can properly extend during folding, avoiding breakage. Furthermore, the first sheet includes a folding edge to permit easy folding of the plural sheets along the folding edge. Furthermore, two first fusion lines are provide to securely connect the first and second sheets through fusion, and the two first fusion lines are located on two sides of the folding line.

In the present invention, by providing the two first fusion lines to connect the plural sheets through fusion, when the plural sheets (such as the first and second sheets) are folded along the folding edge, the sheet at the inner side will generate a corrugation area due to the above-mentioned “inner side effect”. Nevertheless, the corrugation area spreading towards two sides will be stopped by the two first fusion lines providing an isolation effect. Thus, the corrugation area cannot spread further and are, thus, effectively restricted between the two first fusion lines. Therefore, if the spacing between the two first fusion lines can be reduced as much as possible, the corrugation area is accordingly minimized, such that the region of the plural sheets outside of the corrugation area can be maintained smooth after folding the plural sheets. Theoretically, the spacing between the two first fusion lines is the smaller the better (because the corrugation area is smaller). The spacing between the two first fusion lines must be limited to assure the functionality of two first fusion lines in stopping outward spread of the corrugation area. Specifically, the spacing between the two first fusion lines is twice the superimposed thickness of the plural sheets to effectively stop outward spread of the corrugation area.

Although the folding structure according to the present invention is not complicated, the folding structure can effectively overcome the drawbacks of the prior art. Thus, it is appreciated that the present invention is not easy to achieve nor obvious.

The present invention will become clearer in light of the following detailed description of illustrative embodiments of this invention described in connection with the drawings.

### DESCRIPTION OF THE DRAWINGS

FIG. 1 is a diagrammatic view of a document folder of a first embodiment according to the present invention.

FIG. 1A is a diagrammatic view of the document folder of the first embodiment in a folded state.

FIG. 1B diagrammatically show a spacing between two folding lines and the thickness of plural sheets of the document folder first embodiment before and after folding.

FIG. 2 is a diagrammatic view of a document folder of a second embodiment according to the present invention.

FIG. 2A is a diagrammatic view of the document folder of the second embodiment in a folded state.

FIG. 3 is a diagrammatic view of a document folder of a third embodiment according to the present invention.

FIG. 4 is a diagrammatic view of a document folder of a fourth embodiment according to the present invention.

FIG. 4A is a diagrammatic view of the document folder of the fourth embodiment in a folded state.

FIG. 5 is a diagrammatic view illustrating an example of fusion lines in the form of a plurality of spaced dots along straight lines.

FIG. 6A is a diagrammatic view of a conventional document folder.

FIG. 6B is a diagrammatic view of the conventional document folder before folding.

FIG. 6C is a diagrammatic view of the conventional document folder after folding.

### DETAILED DESCRIPTION OF THE INVENTION

The present invention relates to a folding structure for a plastic plural-sheet stationary. Specifically, the present invention relates to a plastic plural-sheet stationary comprising plural plastic sheets that are superimposed on one another. The plastic plural sheets includes at least two element sheets made of plastic. The outermost element sheet includes a folding edge. Two first fusion lines are provided to securely connect the plural plastic sheets formed by the superimposed element sheets through fusion. The two first fusion lines are located on two sides of the folding edge. A spacing between the two first fusion lines is greater than twice a superimposed thickness of the plural plastic sheets. The present invention will be set forth by way of example embodiments.

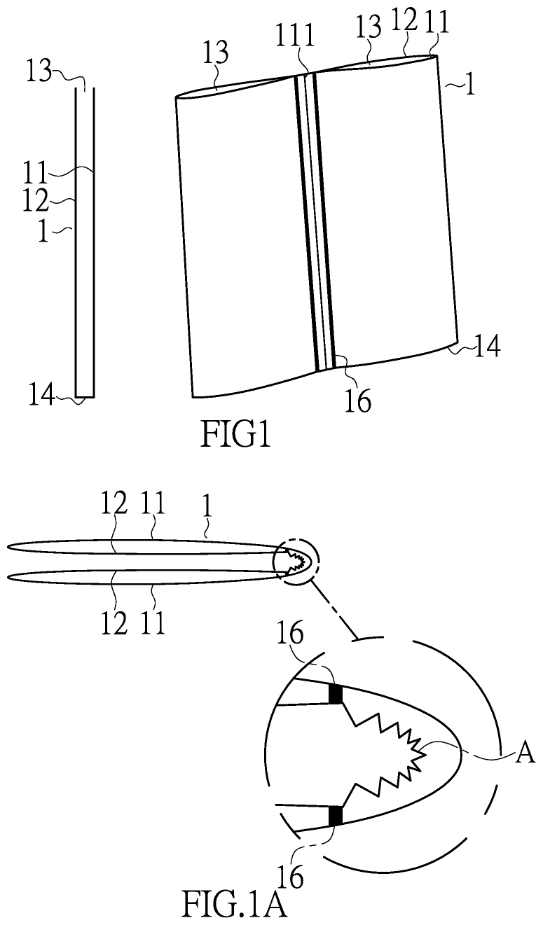

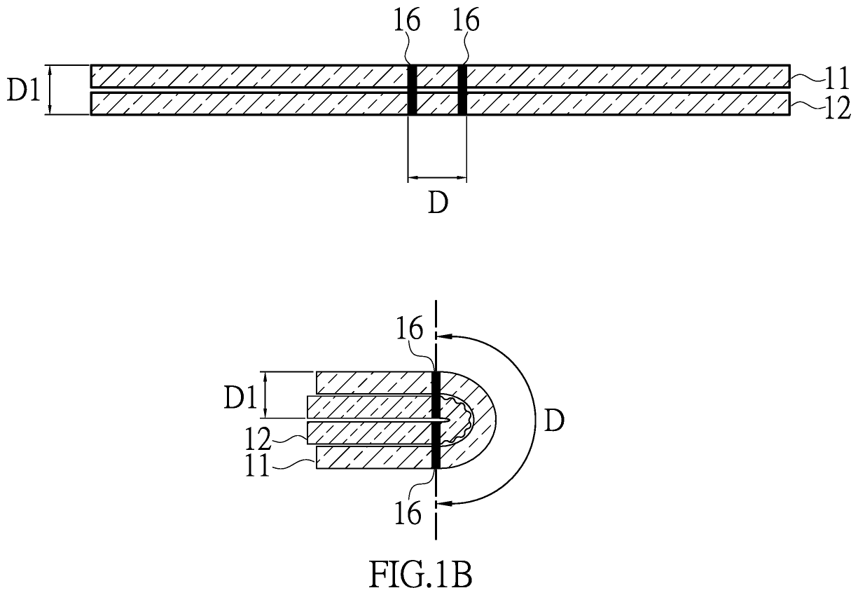

With reference to FIGS. 1 and 1A, a first embodiment according to the present invention relates to a plural-sheet folding structure for a foldable document folder 1. The document folder 1 includes a first sheet 11 which is plastic. A second sheet 12 is superimposed on an inner side of the first sheet 11. The first sheet 11 and the second sheet 12 define a first pocket including a first pocket opening 13 and a closed bottom 14 opposite to the first pocket opening 13. The first sheet 11 includes a folding edge 111. The document folder 1 includes two first fusion lines 16 to securely connect the first sheet 11 and the second sheet 12 by fusion, such that the two first fusion lines 16 are located on two sides of the folding edge 111. The spacing between the two first fusion lines 16 is greater than twice a superimposed thickness of the first sheet 11 and the second sheet 12.

The term “folding edge” used herein refers to a pattern or trace formed by applying an external force before the manufacturing process, so as to provide convenience for subsequent processing or use.

In this embodiment, the first sheet 11 includes a folding edge 111 to permit easy folding of the plural sheets (such as the first and second sheets 11 and 12) along the folding edge 111. Furthermore, two first fusion lines 16 are provided to securely connect the plural sheets by fusion, and the two first fusion lines 16 are located on two sides of the folding edge 111.

According to the present invention, by the provision of the two first fusion lines 16 that securely connect the plural sheets together by fusion, when the plastic plural sheets (such as the first and second sheets 11 and 12) are folded along the folding line 111, the second sheet 12 at the inner side will be affected by the above-mentioned “inner side effect” and, thus, will inevitably generate a corrugation area A around the around the superimposed portion (particularly the folding portion). Nevertheless, when the corrugation area A spreads to the two first fusion lines 16, the two first fusion lines 16 stops the spread (providing an isolation effect), avoiding further outward spread of the corrugation area A. Thus, the corrugation area A will be restricted between the two first fusion lines 16. Theoretically, if the spacing between the two first fusion lines 16 is minimized, most region (the region outside of the corrugation area A) of the plural sheets after folding can be maintained smooth (not affected by the corrugation area A). This is because the spacing between the two first fusion lines 16 is minimized and, thus, minimize the corrugation area A, such that the surface smoothness of the plural sheets is scarcely affected.

Theoretically, the spacing between the two first fusion lines 16 is the smaller the better, because the corrugation area A is smaller. Nevertheless, the spacing between the two first fusion lines 16 must be limited when considering the structural change occurred during folding of the plural sheets. In an embodiment shown in FIGS. 1B, the spacing between the two first fusion lines 16 of the plural sheets of this embodiment is d, and the superimposed thickness of the plural sheets is d1. The superimposed thickness of the plural sheets is 2d1 after folding. Obviously, when d>2d1, the corrugation area A will be located between the two first fusion lines 16. When d<2d1, a portion of the corrugation area A is located outside of the two first fusion lines 16. Thus, d must be greater than 2d1 to assure the functionality of the two first fusion lines 16 for restricting the corrugation area A between the two first fusion lines 16. Namely, the spacing between the two first fusion lines 16 must be greater than twice the superimposed thickness of the plural sheets. Accordingly, the spacing between the two first fusion lines 16 must be greater than twice the superimposed thickness of the plural sheets according to the present invention. This assures the functionality of the two first fusion lines 16 to restrict the corrugation area A between the two first fusion lines 16.

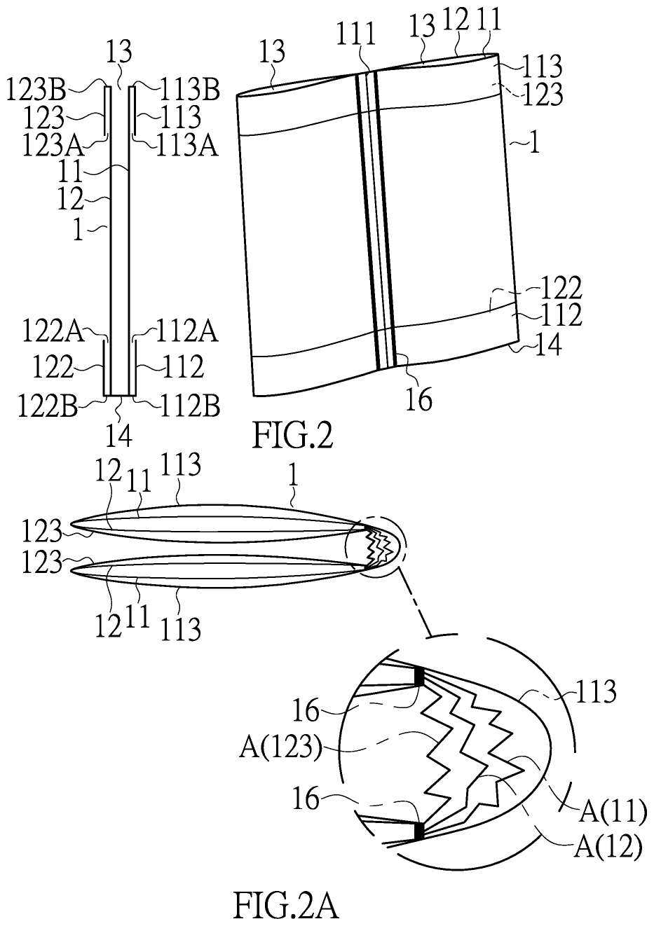

With reference to FIG. 2 showing a second embodiment according to the present invention, to provide various applications of the document folder, the first sheet 11 further includes a first outer pocket layer 112 superimposed on an outer side thereof and located adjacent to the closed bottom 14 of the first pocket. The first outer pocket layer 112 and the first sheet 11 define a second pocket including a second pocket opening 112A facing upwards and a closed bottom 112B opposite to the second pocket opening 112A. The second sheet 12 includes a second outer pocket layer 122 superimposed on an outer side thereof and located adjacent to the closed bottom 14 of the first pocket. The second outer pocket layer 122 and the second sheet 12 define a third pocket including a third pocket opening 122A facing upwards and a closed bottom 122B opposite to the third pocket opening 122A. The two first fusion lines 16 extend through the first outer pocket layer 112 and the second outer pocket layer 122 to securely connect the first and second outer pocket layers 112 and 122 and the first and second sheets 11 and 12 together by fusion. The spacing between the two first fusion lines 16 is greater than twice a superimposed thickness of the first and second sheets 11 and 12 and the first and second outer pocket layers 112 and 122.

Still referring to FIG. 2, to provide various applications of the document folder, the first sheet 11 further includes a third outer pocket layer 113 superimposed on the outer side thereof and located adjacent to the first pocket opening 13 of the first pocket. The first sheet 11 and the third outer pocket layer 113 define a fourth pocket including a fourth pocket opening 113A and a closed bottom 113B opposite to the fourth pocket opening 113A. The fourth pocket opening 113A and the second pocket opening 112A face each other.

The second sheet 12 further includes a fourth outer pocket layer 123 superimposed on the outer side thereof and located adjacent to the first pocket opening 13 of the first pocket. The fourth outer pocket layer 123 and the second sheet 12 define a fifth pocket including a fifth pocket opening 123A and a closed bottom 123B opposite to the fifth pocket opening 123A. The fifth pocket opening 123A and the third pocket opening 122A face each other. The two first fusion lines 16 extend through the third outer pocket layer 113 and the fourth outer pocket layer 123 to connect the third and fourth outer pocket layers 113 and 123 and the first and second sheets 11 and 12 together by fusion. The spacing between the two first fusion lines 16 is greater than twice a superimposed thickness of the first and second sheets 11 and 12 and the third and fourth outer pocket layers 113, 123.

The corrugation area of the third and fourth outer pocket layers 113 and 123 and the first and second sheets 11 and 12 fused together is diagrammatically shown in an example embodiment shown in FIG. 2A.

It is noted that when the plural sheets are folded, aside from the third outer pocket layer 113, the corrugation area A at any other sheet or any other two sheets can be stopped by the two first fusion lines 16 providing the isolation effect, thereby avoiding outward spread of the corrugation area A. Thus, the corrugation area A can be effectively restricted between the two first fusion lines 16, such that the region outside of the corrugation area A can be maintained smooth.

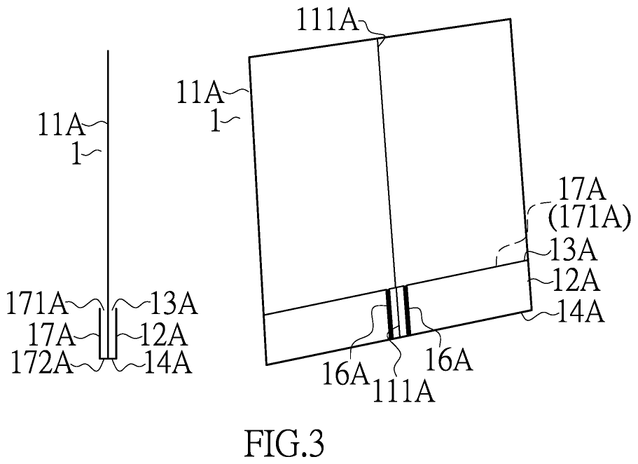

With reference to FIG. 3 showing a third embodiment according to the present invention, to provide various applications of the document folder, the length of the second sheet 12A is smaller than the length of the first sheet 11A. The first sheet 11A and the second sheet 12A also define a first pocket having a first pocket opening 13A and a closed bottom 14A opposite to the first pocket opening 13A.

The first sheet 11A further includes a fifth sheet 17A superimposed on an outer side thereof opposite to the second sheet 12A and identical to the second sheet 12A. The fifth sheet 17A and the first sheet 11A define a sixth pocket including a sixth pocket opening 171A facing a direction identical to that of the first pocket opening 13A. The sixth pocket further includes a closed bottom 172A opposite to the sixth pocket opening 171A. The two first fusion lines 16A extend through the fifth sheet 17A to securely connect the fifth sheet 17A and the first and second sheets 11A, 12A together by fusion.

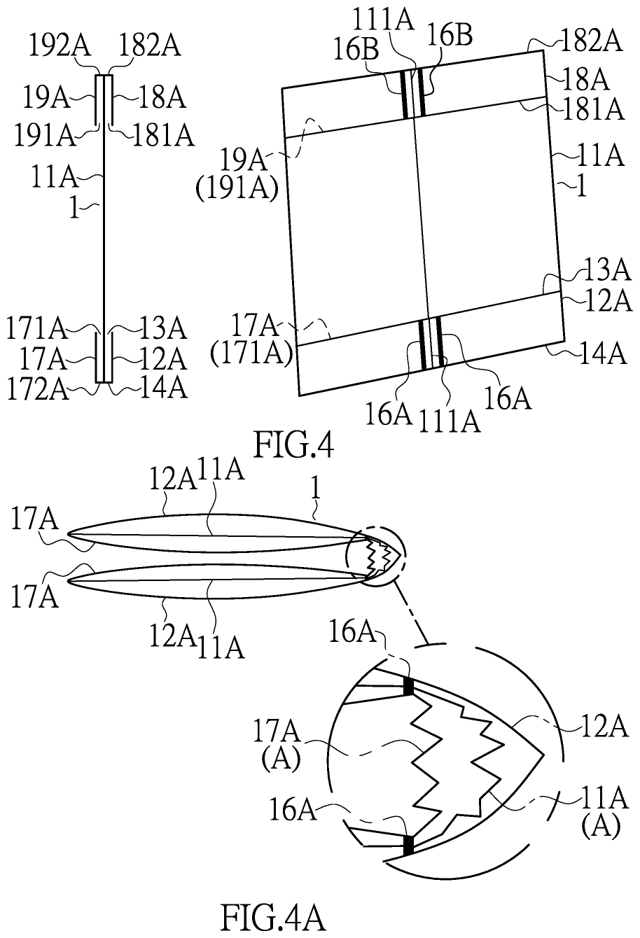

With reference to FIG. 4 showing a fourth embodiment according to the present invention based on the third embodiment, to provide various applications of the document folder, the first sheet 11A further includes a sixth sheet 18A superimposed on the inner side thereof and spaced from the second sheet 12A. The sixth sheet 18A and the first sheet 11A define a seventh pocket including a seventh pocket opening 181A and a closed bottom 182A opposite to the seventh pocket opening 181A. The seventh pocket opening 181A and the first pocket opening 13A formed between the first and second sheets 11A, 12A face each other.

The first sheet 11A further includes a seventh sheet 19A superimposed on the outer side thereof opposite to the sixth sheet 18A. The seventh sheet 19A and the first sheet 11A define an eighth pocket including an eighth pocket opening 191A and a closed bottom 192A opposite to the eighth pocket opening 191A. The eighth pocket opening 191A and the sixth eighth pocket opening 171A face each other. Two second fusion lines 16B are provided to securely connect the sixth sheet 18A, the seventh sheet 19A, and the first sheet 11A together by fusion. The two second fusion lines 16B are located on two sides of the folding edge 111A.

The corrugation area of the first sheet 11A, the second sheet 12A, and the fifth sheet 17A (which are referred to as “plural sheets”) fused together is diagrammatically shown in an example embodiment shown in FIG. 4A.

It is noted that when the plural sheets are folded, aside from the second sheet 12A, the corrugation area A at any other sheet or any other two sheets can be stopped by the two first fusion lines 16 providing the isolation effect, thereby avoiding outward spread of the corrugation area A. Thus, the corrugation area A can be effectively restricted between the two first fusion lines 16, such that the region outside of the corrugation area A can be maintained smooth.

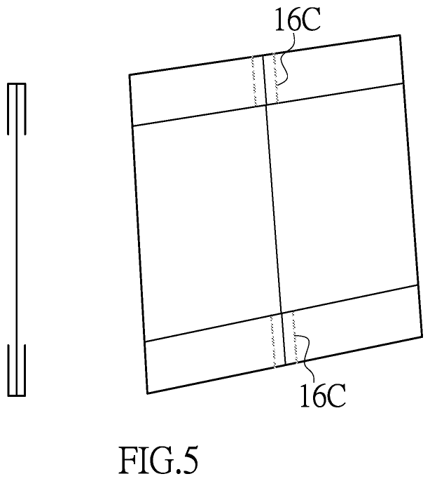

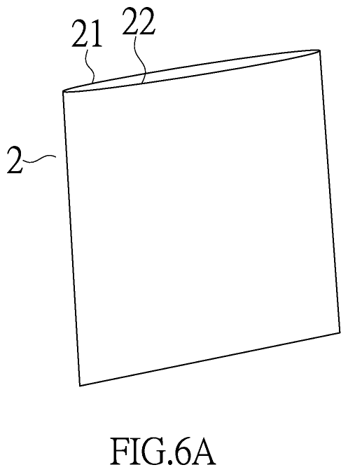

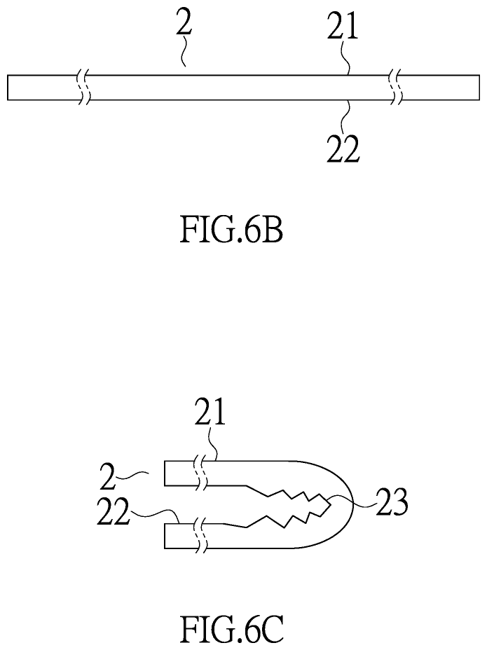

A non-restrictive example of the fusion lines 16C (including the first and second fusion lines) is shown in FIG. 5. It is noted that in the various embodiments according to the present invention, each of the two first fusion lines and the two second fusion lines may be a continuous line or comprised of a plurality of dots spaced from each other along a straight line.

Although specific embodiments have been illustrated and described, numerous modifications and variations are still possible without departing from the scope of the invention. The scope of the invention is limited by the accompanying claims.

What is claimed is:

1. A plastic plural-sheet stationary comprising plural plastic sheets that are superimposed on one another, wherein the plastic plural sheets includes at least two element sheets made of plastic, wherein an outermost element sheet includes a folding edge, wherein two first fusion lines are provided to securely connect the plural plastic sheets formed by the superimposed element sheets through fusion, wherein the two first fusion lines are located on two sides of the folding edge, and wherein a spacing between the two first fusion lines is greater than twice a superimposed thickness of the plural plastic sheets.

2. The plastic plural-sheet stationary as claimed in claim 1, wherein the plastic plural-sheet stationary is a document folder including a first sheet and a second sheet superimposed on an inner side of the first sheet, wherein the first sheet and the second sheet define a first pocket including a first pocket opening and a closed bottom opposite to the first pocket opening, wherein the first sheet includes the folding edge, wherein the document folder includes the two first fusion lines to securely connect the first sheet and the second sheet by fusion, such that the two first fusion lines are located on two sides of the folding edge, and wherein the spacing between the two first fusion lines is greater than twice a superimposed thickness of the first sheet and the second sheet.

3. The plastic plural-sheet stationary as claimed in claim 2, wherein the first sheet includes a first outer pocket layer superimposed on an outer side thereof and located adjacent to the closed bottom of the first pocket, wherein the first outer pocket layer and the first sheet define a second pocket including a second pocket opening facing upwards and a closed bottom opposite to the second pocket opening, wherein the second sheet includes a second outer pocket layer superimposed on an outer side thereof and located adjacent to the closed bottom of the first pocket, wherein the second outer pocket layer and the second sheet define a third pocket including a third pocket opening facing upwards and a closed bottom opposite to the third pocket opening, wherein the two first fusion lines extend through the first outer pocket layer and the second outer pocket layer to securely connect the first and second outer pocket layers and the first and second sheets together by fusion, and wherein the spacing between the two first fusion lines is greater than twice a superimposed thickness of the first and second sheets and the first and second outer pocket layers.

4. The plastic plural-sheet stationary as claimed in claim 3, wherein the first sheet includes a third outer pocket layer superimposed on the outer side thereof and located adjacent to the first pocket opening of the first pocket, wherein the first sheet and the third outer pocket layer define a fourth pocket including a fourth pocket opening and a closed bottom opposite to the fourth pocket opening, wherein the fourth pocket opening and the second pocket opening face each other, wherein the second sheet includes a fourth outer pocket layer superimposed on the outer side thereof and located adjacent to the first pocket opening of the first pocket, wherein the fourth outer pocket layer and the second sheet define a fifth pocket including a fifth pocket opening and a closed bottom opposite to the fifth pocket opening, wherein the fifth pocket opening and the third pocket opening face each other, wherein the two first fusion lines extend through the third outer pocket layer and the fourth outer pocket layer to securely connect the third and fourth outer pocket layers and the first and second sheets together by fusion, and wherein the spacing between the two first fusion lines is greater than twice a superimposed thickness of the first and second sheets and the third and fourth outer pocket layers.

5. The plastic plural-sheet stationary as claimed in claim 2, wherein a length of the second sheet is smaller than a length of the first sheet, wherein the first sheet further includes a fifth sheet superimposed on an outer side thereof opposite to the second sheet and identical to the second sheet, wherein the fifth sheet and the first sheet define a sixth pocket including a sixth pocket opening facing a direction identical to that of the first pocket opening, wherein the sixth pocket further includes a closed bottom opposite to the sixth pocket opening, and wherein the two first fusion lines extend through the fifth sheet to securely connect the fifth sheet and the first and second sheets together by fusion.

6. The plastic plural-sheet stationary as claimed in claim 5, wherein the first sheet further includes a sixth sheet superimposed on the inner side thereof and spaced from the second sheet, wherein the sixth sheet and the first sheet define a seventh pocket including a seventh pocket opening and a closed bottom opposite to the seventh pocket opening, wherein the seventh pocket opening and the first pocket opening formed between the first and second sheets face each other, wherein the first sheet further includes a seventh sheet superimposed on the outer side thereof opposite to the sixth sheet, wherein the seventh sheet and the first sheet define an eighth pocket including an eighth pocket opening and a closed bottom opposite to the eighth pocket opening, wherein the eighth pocket opening and the sixth eighth pocket opening face each other, wherein two second fusion lines are provided to securely connect the sixth sheet, the seventh sheet, and the first sheet together by fusion, and wherein the two second fusion lines are located on two sides of the folding edge.

7. The plastic plural-sheet stationary as claimed in claim 6, wherein each of the two first fusion lines and the two second fusion lines is comprised of a plurality of dots spaced from each other along a straight line.

8. The plastic plural-sheet stationary as claimed in claim 1, wherein each of the two first fusion lines is comprised of a plurality of dots spaced from each other along a straight line.
